(19) United States
(12) Patent Application Publication
(10) Pub. No.: US 2021/0409893 A1
(43) Pub. Date: Dec. 30, 2021

(54) AUDIO CONFIGURATION FOR DISPLAYED FEATURES

(71) Applicant: Microsoft Technology Licensing, LLC, Redmond, WA (US)

(72) Inventor: Steven M. Sommer, Snoqualmie, WA (US)

(21) Appl. No.: 16/912,347

(22) Filed: Jun. 25, 2020

(51) Int. Cl. H04S 7/00; G06T 7/70; G06K 9/00

(52) U.S. Cl. CPC H04S 7/304; G06T 7/70; H04N 7/15; G06T 2207/30201; G06T 2207/10016; G06K 9/00288

(57) ABSTRACT

Techniques for distributing audio to configure a sound field for a user viewing features displayed on a hardware display are disclosed herein. A position of the user may be calculated based on captured image data, and the calculated position may be used to calculate a position of the user relative to a feature on the hardware display. A sound field for the user may be modified and generated in accordance with the calculated position of a user relative to the feature display on the hardware display.

### TECHNICAL FIELD

This document pertains generally, but not by way of limitation, to audio output, and particularly but not by way of limitation to configuration of sound fields for displayed features.

### BACKGROUND

Several applications exist in which users view one or more speakers or other objects in live or pre-recorded video such as communication applications, video streaming applications, video games, and the like. During a network-based communication session for example, users may exchange live audio, video, and/or may share other content such as pre-recorded audio, pre-recorded video, application data, screen sharing, and the like.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a network diagram illustrating several computing devices configured to display active speakers or other features, and output audio to a user.

FIG. 2 is a diagram illustrating an example graphical user interface provided by a communication application for a user of a network-based communication session.

FIGS. 3A-3E are diagrams illustrating an example system for identifying a relative position of a user viewing video.

FIG. 4 is a flowchart illustrating a method for configuring a sound field based on a displayed position of a feature on a display.

FIG. 5 is a flowchart illustrating a method for configuring a sound field based on a relative position of a user to a displayed position of a feature on a display.

FIG. 6 is a block diagram illustrating an example of a machine upon which one or more embodiments may be implemented.

### DETAILED DESCRIPTION

Systems and methods are disclosed herein that facilitate configuring a sound field (e.g., panning) output to users viewing features on a display. The features may be participants in an online communication session, persons or other speakers in a pre-recorded or live video, characters in a movie or video game, or any other feature displayed on a hardware display. A user often listens to audio that accompanies video displayed on the hardware display through one or more speakers, such as headphones, integrated speakers, desktop speakers, or the like.

Audio for the active speaker is conventionally provided to each speaker equally (e.g., monophonic), preventing the user from feeling immersed in the experience. To further enhance the experience of a user viewing the feature, such as an active speaker, audio for the active speaker can be panned or otherwise distributed to each speaker (e.g., stereophonic) based on a displayed position of the active speaker on the hardware display. This provides a sound field for the user that provides the user with the feeling of being in the same room as the active speaker. For example, if an active speaker is displayed on the right side of the display as the user faces the display, the audio of the active speaker may be panned to the right such that a greater signal strength is provided to one or more speakers positioned to the right of the user (such a right earphone) as compared to one or more speakers positioned to the left of the user (such as a left earphone). If a second active speaker is displayed on the left side of the display as the user faces the display, the audio of the second active speaker may be panned to the left. If the active speakers move to different positions on the display, the respective audio can be panned accordingly.

However, a user viewing the hardware display may not always be directly in front of the display or may move while viewing the display. This results in a technical problem of the user experiencing audio for a feature, such as an active speaker, coming from a direction different than the direction of the displayed active speaker when solely panning audio based on the displayed position of the active speaker. As a technical solution to this problem, panning or otherwise distributing the audio can also be based on a physical position of the user with respect to the displayed feature(s).

To identify a position of the user, image or video data may be captured by a camera, such as a video camera, or other imaging device. In some examples, one or more video frames may be captured by the camera and used as image data. The position of the user within the image data may be obtained using one or more methods of feature recognition, for example. In some examples, feature recognition may be used to determine whether the position of the user in the image data indicates that the user is to the right or the left of the displayed feature. In other examples, more detail regarding the physical position of the user may be estimated based on the identified position of the user within the image data, such as an angle of the user with respect to the feature, a distance from the display, an amount of distance to the left or right of the feature, and the like.

Once the relative position of the user is estimated with respect to the displayed feature, the audio for the feature, such as an active speaker, may distributed to two or more audio channels in accordance with the estimated relative position to further configure the sound field provided to the user. For example, even if the feature is displayed on the left side of the display, if the user is physically positioned to the left of the displayed feature, the audio for the displayed feature may be panned to the right (i.e., distributed to an audio channel associated with a right speaker). This provides the technical effect of the user experiencing the audio coming from the displayed feature, regardless of the physical position of the user, or if the user moves throughout the room. As the user moves throughout the room, further image or video data may be captured, and the relative position of the user may be updated such that the distribution of the audio may be updated accordingly.

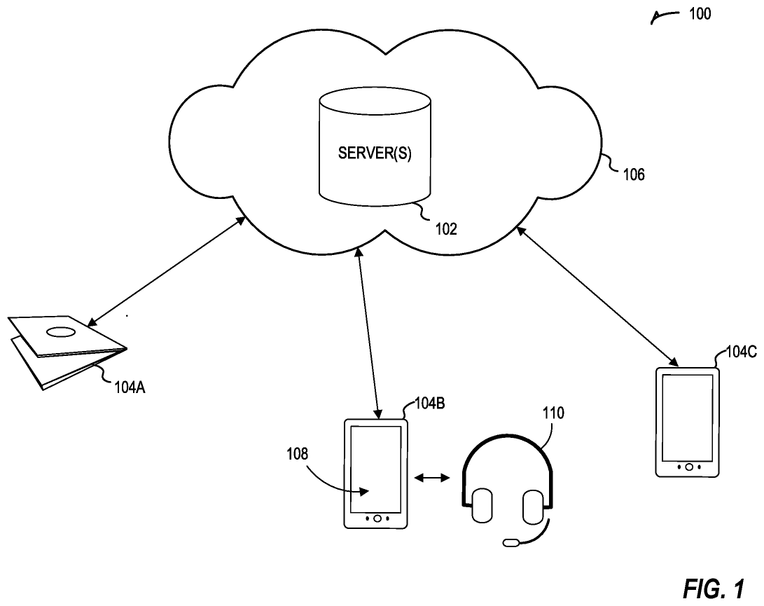

FIG. 1 is a diagram illustrating an example system 100 for distributing audio to various audio channels based on displayed features. The system 100 includes one or more servers 102 and user devices 104A-104C. The user devices 104A-104C may be any user devices connected to the one or more servers 102 through one or more networks 106. The user devices 104A-104C include associated display devices and audio output devices. For example, a tablet or mobile device may include an integrated display 108 and connect to a headset 110 to output audio.

The one or more networks 106 may include cellular networks, local area networks, wide area networks, and the like. For example, the networks 106 may include the wireless networks such as 3rd generation (3G), 4th generation (4G), long term evolution (LTE), 5th generation (5G) or any other cellular network, wireless networks according to the Institute of Electrical and Electronics Engineers (IEEE) 802.11 family of standards known as Wi-Fi®, and the like. The user devices 104A-104C may be configured to communicate with the servers 102 through any connection, including wired and wireless connections. Each user device 104A-104C, which may be a phone, tablet, laptop, television, or other computing device, may be configured to upload data to, and download data from, the servers 102. In some examples, the user devices 104A-104C may be configured to communicate directly with one another over the networks 106.

The servers 102 may include one or more applications configured to provide video and audio data to the user devices 104A-104C. In some examples, the application is a communication service configured to enable network-based communication sessions between users. In some examples, the user devices 104A-104C may execute an “offline” application such that communication with the servers 102 is not needed. For example, the user devices 104A-104C may execute a video playback application that outputs a pre-recorded video to an associated display. In other examples, the servers 102 may provide video streaming or other services that provide a displayed feature, such as an active speaker, to one or more user devices 104A-104C. In other examples, the user devices 104A-104C may execute local applications to communicate directly with other user devices 104A-104C.

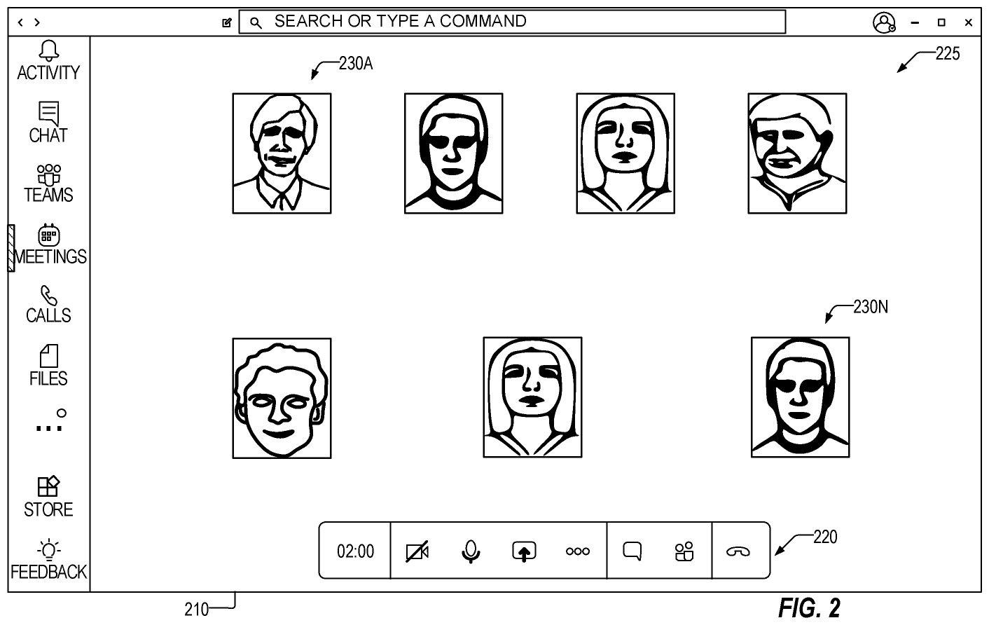

FIG. 2 is a diagram illustrating an example display that includes active speakers as features for which audio may be distributed to two or more audio channels to configure a sound field for a user. In the example illustrated in FIG. 2, the display includes a graphical user interface 210 provided by a communication application for a network-based communication session. Other examples may include applications such as video streaming services, video playback services, video game services, or any other applications that display one or more active speakers on a display.

The graphical user interface 210 may be output on a hardware display, such as a touchscreen, liquid crystal display (LCD) device, light-emitting diode (LED) display device, and the like. Meeting control bar 220 may include video controls, audio controls, sharing controls, recording controls, and the like. One such audio control may allow the user to enable/disable sound field configuration (e.g., audio panning) for the communication session.

The stage 225 may present one or more representations of participants in the meeting or video streams of the users at various positions on the user interface 210. If the participant does not have video streaming enabled or does not have a video capture device, the participant may be represented by an avatar. If a participant has video enabled and is streaming, the video may be shown on the stage 225. All the participants in the meeting shown in FIG. 2 have video enabled.

The stage layout may be a grid-layout with each video stream shown in a same size box with the video stream cropped to a head-and-shoulders perspective and aligned with a neighboring video stream in one or more of a row or column. In other examples, each video stream may be in a native resolution. In still other examples, some video streams may be rendered larger as an indication of a relative importance of the user. For example, an active speaker's video stream may be enlarged.

With sound field configuration enabled, audio for respective participants may be distributed to two or more audio channels according to a displayed position of the participant to adjust the sound field provided to the user. Each participant may be displayed at a respective location 230A-230N on the stage 225. For example, one participant is displayed at a location 230A on the top-left of the stage 225 while another participant is displayed at a location 230N at the bottom-right of the stage 225. Audio (e.g., voice) for the participant displayed at the location 230A may be panned to the left while audio for the participant displayed at the location 230N may be panned to the right. Sound field configuration may be performed by the communication server 130, or any of the respective computing devices 110-113.

In some examples, sound field configuration may be achieved by distributing audio signals to two or more respective channels of an audio stream. For example, a user may be using headphones having a left ear speaker and a right ear speaker. One channel may be provided to the left ear speaker and another channel may be provided to the right ear speaker. When panning audio to the right, for example, audio data for a participant may be distributed at greater strength (e.g., greater decibel level) to the channel for the right speaker.

Audio can be panned at varying levels to adjust the sound field for the user. For example, audio can be panned entirely to the left such that the audio data is provided to the left channel at a high/full signal strength while the audio data is provided to the right channel at zero signal strength. The amount that the audio is panned for a respective participant may be based on how far right or left the participant is displayed on the display. For example, for a participant displayed just left of center, the audio may be panned slightly to the left (slightly greater signal strength provided to the left channel vs. the right channel for the respective audio data), and for a participant displayed at the far left of the display the audio may be panned further to the left (e.g., zero strength for the right channel).

In other examples, there may be more than two audio channels for outputting audio to one or more users. For example, in a conference room, there may be more than two speakers distributed throughout the room, each having a respective audio channel. The audio data for participants may be distributed to the channels based on the displayed position of a respective participant. For example, the vertical position on the stage 225 may be considered along with the horizontal position. For example, the participant displayed at the location 230A may have respective audio data distributed to a channel for a front-left speaker in the conference room (e.g., greater signal strength is provided to the front-left speaker as compared to the other speakers) as the participant is displayed at a top-left location of the stage 225. Likewise, the participant displayed at the location 230N may have respective audio data distributed (e.g., panned) to a channel for a back-right speaker in the conference room as the participant is displayed at a bottom-right location of the stage 225. This provides a sound field that gives the users in the conference room the experience of having the remote participants in the room.

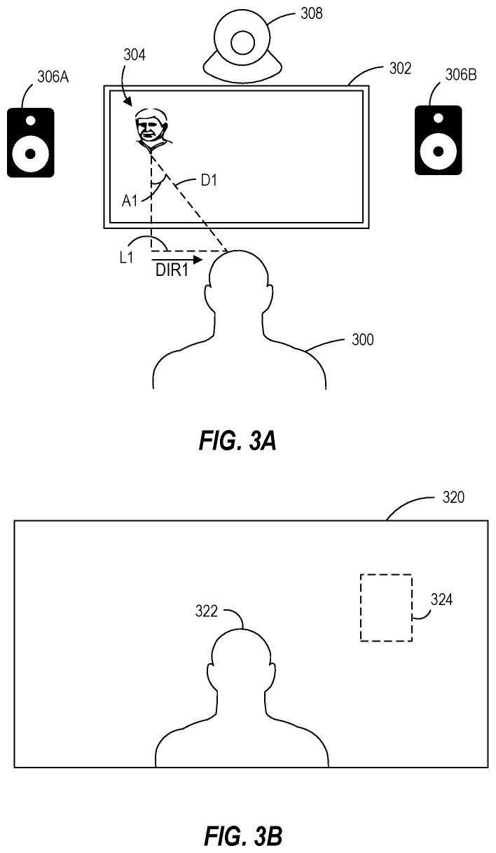

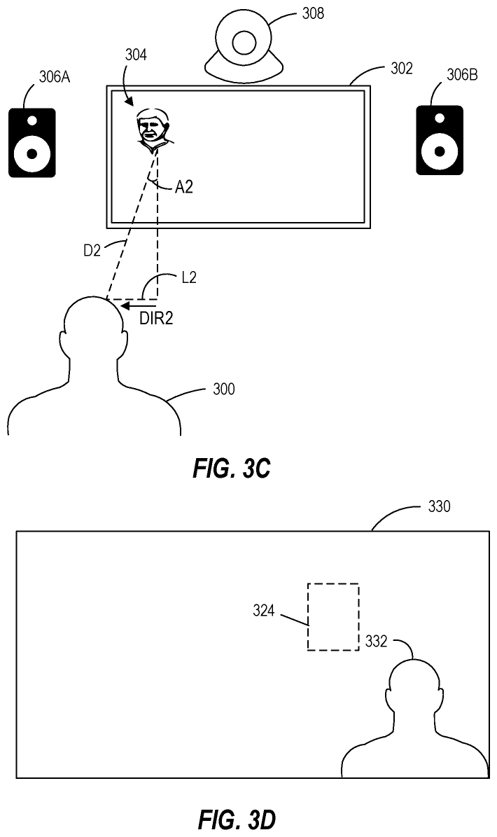

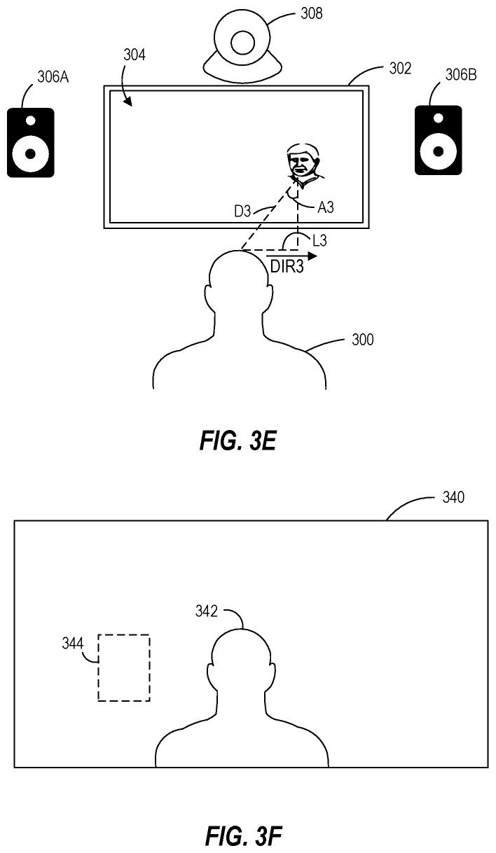

A user is not always positioned directly in front of a display or the user may move while viewing the display. Thus, it may be desirable to identify the position of the user viewing the display and update distribution of the audio signals accordingly to adjust the sound field accordingly. FIGS. 3A-3D are diagrams illustrating an example system for identifying a relative position of a user utilizing a computing device or other display device, such as a television. Audio data can be distributed further based on the relative position of the user that is using the display. For example, if a user is positioned to the left of the user's display, panning audio to the left would not provide a sound field that gives the user the experience that the audio is coming from the direction of displayed active speakers, as all displayed active speakers are displayed physically to the right of the user.

FIGS. 3A and 3B illustrate an example of a user 300 positioned directly in front of a display 302. A feature, illustrated as an active speaker 304, is displayed on the display 302. The active speaker 304 may be a participant in a communication session, a person, animal, or other creature in a pre-recorded or live video, a character in a video game, or any other active speaker in any other displayed video. Audio for the active speaker 304 may be output to the user 300 to provide a sound field from speakers 306A and 306B. For example, a first audio channel may be implemented to provide a signal to a bus for the speaker 306A and a second audio channel may be implemented to provide a signal to a bus for the speaker 306B to output audio to the user 300 to generate the sound field. Image data of the user may be obtained using a camera 308 or other image or video capture device. While illustrated as one camera 308 and two speakers 306A and 306B, any number of cameras and speakers may be used.

FIG. 3B illustrates example image data 320 captured by the camera 308. The image data 320 may be used to determine the relative position of the user 300 to a displayed feature (e.g., active speaker 304). While illustrated as a single image frame in FIG. 3B, multiple image frames may be used to identify a position of the user 300. In some examples, a distance ‘D1’, an angle ‘A1’, a direction ‘DIR1’, and/or a lateral distance ‘L1’ may be estimated using the image data 320. In some examples, only the direction DIR1 (e.g., right or left) may be estimated. To estimate these parameters, facial recognition, object recognition, feature recognition, or any other image processing techniques may be used. For example, edge detection, ridge detection, corner detection, blob detection, or any other feature or object recognition technique may be used to identify the user image data 322 indicative of the user 300 in the image data 320.

The user image data 322 may be analyzed to determine one or more positional parameters of the user 300 with respect to the displayed active speaker 304. In some examples, a reference 324 may be used for the displayed participant 304 providing a relative position of the displayed active speaker 304 within the image data 320. For example, an application may know the position of the active speaker 304 and generate/overlay the position on the image data 320.

In some examples, to identify a position of the user 300 with respect to the display 302 and with respect to a displayed feature such as the active speaker 304, a coordinate system for the image data 320 (obtained by the camera 308), and a coordinate system for the display data may be registered or mapped to each other. For example, using the coordinate systems for the display data and the image data 320, physical positions of the display 302 and the camera 308, and device characteristics of the display 302 and the camera 308, positions of the user 300 may be identified. For example, an application executing on a computing device associated with the display 302 and the camera 308 may know, sense, or otherwise receive physical positions of the display 302 and the camera 308, resolutions of the display 302 and image data 320 and other characteristics of the display 302 and camera 308. Using this information, the applications may map or register the coordinate system for the image data 320 and the coordinate system for the display data through one or more mathematical transformations to identify one or more positions of the user 300.

In one example, a position of the user 300 within the image data 320 may be obtained through mapping of multiple coordinate frames with respect to the camera 308. For example, position data may be obtained through mapping of a world coordinate frame, to a camera coordinate frame, and to a coordinate frame of the image data 320. The world coordinate frame may be three-dimensional coordinates fixed in the physical space, such as a fixed location within a room. For example, the fixed location may be the location of the display 302 (such as a top-left corner of the display 302), which may be known, sensed, or otherwise received by applications executing on the computing device. In one example, a sensor or other locating device may be used to provide a physical location of the display 302 to the computing device. The camera coordinate frame may be defined such that an origin of the camera coordinates may be a center of projection of the camera 304 and may be related to the world coordinate frame, such as using a relative position of the center of projection to the camera 304. The z-axis for the camera coordinate frame, for example, may be the optical axis of the camera 304. The physical position of the camera 304 may be known, sensed, or otherwise received by the computing device. Finally, the image coordinate frame may be a three-dimensional vector, mapped to the pixel coordinates of the image data 320. The mapping between these three coordinate frames may be accomplished through one or more mathematical transformations, for example. The image coordinate frame and the pixel coordinates of the user image data 322 within the image data 320 may then be used to identify a physical position of the user 300. Because the world coordinate frame is defined with respect to the location of the display 302, the position of the user 300 with respect to the display 302 can be identified.

The position of the user 300 with respect to the display 302 may then be used to calculate a relative position of the user with respect to a displayed feature (such as the active speaker 304). The pixel location of the displayed feature within the display data, for example, may be used to identify a position of the displayed featured with respect to the world coordinate frame discussed above (e.g., the top-left corner of the display). The position of the displayed feature and the calculated position of the user 300 with respect to the display 302 may then be used to calculate relative position data (e.g., D1, A1, L1, or DIR1) of the user 300 with respect to the displayed feature.

In another example, the pixel coordinate system of the image data 320 may be mapped to the pixel coordinate system of the display data for the display 302 through one or more mathematical transformations. This may be achieved using known, sensed, or otherwise received physical positions of the camera 308 and the display 302. In this example, a reference 324 for the active speaker 304 may be mapped onto the image data 320 through the mapping of the coordinate systems. In this example, a position of the user 300 within the image data 320 with respect to the reference 324 may be used to identify one or more of the parameters D1, A1, L1, and/or DIR1 with respect to the reference 324. For example, a size of the user image data 322 may be used to estimate the distance D1 to the user from the reference 324 and the position of the user image data 322 within the image data 320 may be used to estimate the angle A1 with respect to the reference 324. Using D1 and A1, the lateral distance L1 may be estimated.

A simple direction DIR1 may also be identified from the image data 320. For example, because the user image data 322 is to the left of the reference 324 in the image data 320, the DIR1 can be identified as the user 300 being right of the displayed participant 304 as the user faces the display. In some examples, a reference 324 may not be used, and all position data may be obtained with respect to the camera 308. The position data with respect to the camera 308 may then be analyzed by one or more applications executing on a respective computing device to estimate position data of the user 302 with respect to the displayed active speaker 304.

The position of the camera 308 with respect to the display 302 may be known or identified based on the configuration or characteristics of one or more of the computing device, the display 302, or the camera 308. For example, a laptop, notebook computer, tablet, mobile phone, or other computing device may include both an integrated or otherwise attached display and camera. This way, the relative position of the display 302 with respect to the camera 308 may be fixed or known and may be identified based on the model of the computing device, or by user input, for example, following calibration of an external camera. For example, a tablet computing device may include a camera in a fixed position above a touchscreen display, and a model of the tablet may be used to identify the relative position of the camera with respect to the touchscreen display. In some examples, a computing device, such as a desktop computer, may be connected to a display 302 that includes an integrated or otherwise attached camera 308. In this example, even if the display 302 is moveable with respect to the computing device, the location of the camera 308 is fixed relative to the display 302. In another example, an external camera may be moveable with respect to the display 302 and may be calibrated by the user. The user may then input the respective position of the camera 308 with respect to the display 302 following the calibration.

Applications executing on the computing device may identify the relative position of the camera 308 with respect to the display 302 based on a model of the display 302 having the integrated camera 308, based on user input, or based on any other data. In some examples, applications may identify one or more of a computing device, display, or camera model, and reference a lookup table, database, or data structure to obtain the fixed or known relative positions of the camera 308 and the display 302 using the computing device, camera, or display model as an index. The relative positions of the display 302 and the camera 308 may then be used to map coordinate systems between the display 302 and the camera 308 using methods such as those described herein.

Machine learning may also be used to identify the user 300 within the image data and/or the physical position of the user 300 using the image data 320. For example, one or more applications may use a machine learning model to estimate the above parameters for the user 300. The machine-learning model may output the estimated position data (e.g., D1, A1, L1, and/or DIR1) based upon one or more image frames or other image or video data as input. Example machine-learning algorithms may include logistic regression, neural networks, decision forests, decision jungles, boosted decision trees, support vector machines, and the like.

FIGS. 3C and 3D illustrate an example in which the user 300 has moved to the left with respect to the user's previous position in FIG. 3A. As a result of this move, the user 300 is now left of the displayed active speaker 304 as the user faces the display 302. Thus, it may not be desirable to pan the audio to the left speaker 306A now that the displayed active speaker 304 is to the right of the user 300.

The camera 308 may capture updated image data 330 to capture the new position of the user 300. User image data 332 may be identified within the image data 330 using the methods described above. The position of the user using the user image data 332 may be used to estimate the relative position data (e.g., D2, A2, L2, and/or DIR2) for the user 300 with respect to the displayed active speaker 304 using the methods described above.

The updated relative position data for the user 300 may then be used to update sound field configuration for the audio data for the active speaker 304. For example, the audio data may be distributed to an audio channel associated with the right speaker 306B at a strength greater than the audio channel associated with the left speaker 306A to generate the sound field for the user 300. The strength of the signal provide to each channel may be based on how far left (e.g., using the lateral distance L1) of the displayed active speaker 304 the user is. For example, if the user 300 is estimated to be slightly left of the displayed active speaker 304 (e.g., L1 is on the order of inches), the strength of the audio signal provided to the channel for the right speaker 306B may only be slightly greater than the strength of the audio signal provided to the channel for the left speaker 306B. For example, the signal may be provided at −2 dB to the right speaker 306B, and may be provided at −4 dB to the left speaker. If the user is estimated to be much further left (e.g., L1 is on the order of feet), the strength of the audio signal provided to the channel for the right speaker 306B may be much greater than the strength of the audio signal provided to the channel for the left speaker 306A. For example, full signal strength may be provided to the channel for the right speaker 306B with zero signal strength provided to the channel for the left speaker 306B.

FIGS. 3E and 3F illustrate an example in which the displayed active speaker 304 has moved on the display 302. With respect to FIG. 3A, the active speaker 304 is now displayed to the right of the user 300. Thus, it may not be desirable to pan the audio to the left speaker 306A now that the user 300 is to the left of the displayed active speaker 304. This may have been a result of an application moving the active speaker (e.g., in a communication session), or the active speaker moving through video frames (e.g., in a streamed live video).

The camera 308 may capture updated image data 340 to capture the present position of the user 300. The image data 340 may indicate that the user 300 has not moved. However, the relative position with respect to the displayed active speaker 304 has changed. The position of the user using the user image data 342 may be used to estimate the relative position data (e.g., D3, A3, L3, and/or DIR3) for the user 300 with respect to the displayed active speaker 304 using any of the methods described above. The updated relative position data for the user 300 may then be used to redistribute the audio data for the active speaker 304.

New image data may be captured at any desired rate. For example, if the user 300 is playing a video game such that the user 300 may move frequently, new image data may be captured and/or analyzed at a faster rate (e.g., every millisecond) in order to provide the user with the experience that the user is moving with respect to a displayed feature (e.g., video game character) in the same room. Likewise, if a user 300 is participating in a communication session in which it is likely the user 300 will remain stationary for long periods of time, the image data may be captured and/or analyzed at a slower rate (e.g., ever second).

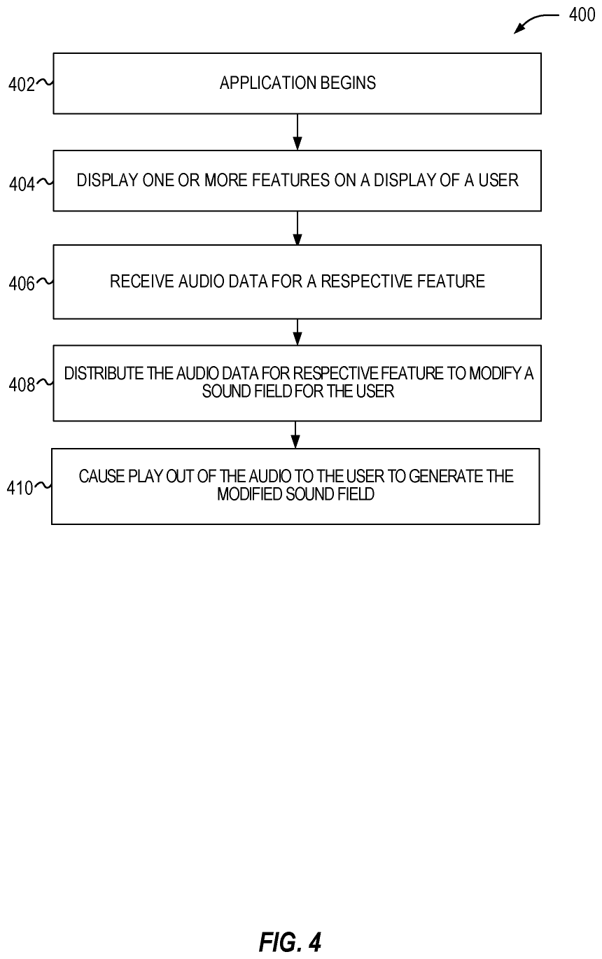

FIG. 4 is a flowchart illustrating a method 400 of configuring a sound field for a user participating in online conferences or using other video applications based on a position of features, such as active speakers, on a display. At step 402, the application is started, and video is output to the display. This may be a video conference through an online conferencing application such as MICROSOFT TEAMS®, a video game, a video streaming service, or any other application in which feature representing an object such as a person, character, animal, or other object is displayed. At step 404, one or more features are displayed on a hardware display of a user, such as a touchscreen display, desktop display (e.g., liquid crystal display (LCD), light-emitting diode (LED) display), and the like. The features are displayed at respective positions on the hardware display as specified by the online communication application, the video data, and the like.

At step 406, audio data is received that corresponds to a respective feature. For example, the feature may be a participant that is speaking in a communication session, or a character that may be speaking a movie. This respective active speaker is positioned at a known position on the hardware display of the user. This known position may be known by the application (e.g., communication client) or may be calculated. For example, one or more applications may be used to identify the position of an active speaker in video data using feature recognition.

An audio stream that includes all audio for the application may be provided to two or more speakers to provide audio of the application to generate a sound field for the user. The speakers may be headphone speakers, desktop speakers, or any other audio output devices configured to output audio to generate a sound field for a user. In one example, two speakers are positioned to provide audio to a user. The speakers may be positioned to the right and the left of the user, respectively. Thus, the audio stream may include two or more audio channels, one for each respective speaker. For example, the audio stream may have a left channel for providing a signal to drive the left speaker and a right channel for providing a signal to drive the right speaker.

At step 408, the audio data for the respective feature is panned or otherwise distributed based on the position of the active speaker on the display to configure the sound field for the user. For example, if video data of a respective feature is positioned on the left side of the display (as the user looks at the display), then the audio may be panned to the left channel (e.g., a stronger signal for the audio data is provided to the left channel than the right channel). The amount of panning to the left channel may be based on the size of the display, how far to the left the participant is displayed on the display, how many active speakers are currently displayed, and the like.

At step 410, the audio stream is output to generate the sound field for the user, such as through respective speakers. The audio stream may include audio data for numerous features. For example, audio data from a feature displayed on a right-hand side of the user's display may be panned mostly to the right channel of the audio stream while the audio data for the feature displayed on the left-hand side of the display may be panned mostly to the left channel of the audio stream. This generates a sound field that allows a user to feel as though the user is in a room with the features (e.g., people speaking on the display), having audio from the features coming from all directions based on the display of the features.

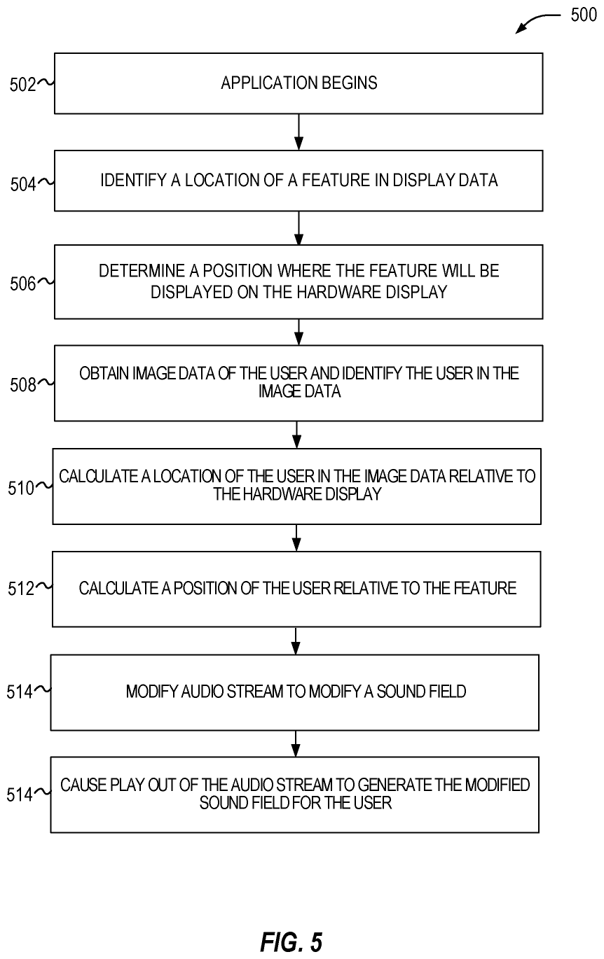

FIG. 5 is a flowchart illustrating a method 500 of configuring a sound field for applications based on a relative position of a user to a displayed position of feature. At step 502, the application is started. This may be a video conference through an online conferencing application such as MICROSOFT TEAMS®, a video game, a video streaming service, or any other application in which feature representing an object such as a person, character, animal, or other object is displayed. At step 504, a location of one or more features is identified in display data for display on a hardware display. This may be identified by the application, or may be provided by the provider of the display data, for example. At step 506, based on the identified location, a position where the feature will be displayed on the hardware display of a user, such as a touchscreen display, desktop display (e.g., liquid crystal display (LCD), light-emitting diode (LED) display), and the like, is determined.

At step 508, image data is obtained for a user. The image data may be captured using a camera, such as a webcam, or any other image or video capture device. For example, the user may be using a laptop computer with an integrated webcam. At step 510, a location of the user in the image data is calculated relative to the hardware display using a relative position of the display and the image capture device, characteristics of the image capture device, and a location of the user within the image data. For example, the application may know or determine coordinate systems of the hardware display and the camera, and may calculate the position of the user with respect to those coordinate systems based on one or more mathematical transformations from a coordinate system of the camera to or from a coordinate system of the display. In an example, the relative distance between the image capture device and the display may be known or fixed based on a model of a computer device that includes the image capture device and display. This may be accomplished using one or more feature recognition techniques, for example, to initially identify a user within the image data.

At step 512, a position of the user relative to the displayed feature is calculated based on the displayed position of the feature and the calculated position of the user with respect to the display. The relative position information may be a direction such as “left” or “right”, or may be more specific such as 5 feet from the feature and 1 foot left of the feature. At step 514, an audio stream for display data is modified to modify a sound field for the user. For example, audio data may be panned based on the relative position information. For example, if the relative position of the participant is to the left of the user, then the audio may be panned to the left channel (e.g., a stronger signal for the audio data is provided to the left channel than the right channel). The amount of panning to the left channel may be based on one or more of the size of the display, how far to the left the participant is with respect to the user, how many participants are currently displayed, and the like.

At step 516, the audio stream is output to the user to generate the modified sound field, such as through respective speakers. For example, the audio data may be added to a left channel of the audio stream and a right channel of the audio stream based on the how far to the right or left the audio data is panned. The audio stream may include audio data for numerous features. For example, audio data from an active speaker displayed on a right-hand side of the user's display may be panned mostly to the right channel of the audio stream while the audio data for the active speaker displayed on the left-hand side of the display may be panned mostly to the left channel of the audio stream. This generates a sound field that allows a user to feel as though the user is in a room with the active speakers, having audio from the active speakers coming from all directions based on the display of the active speakers.

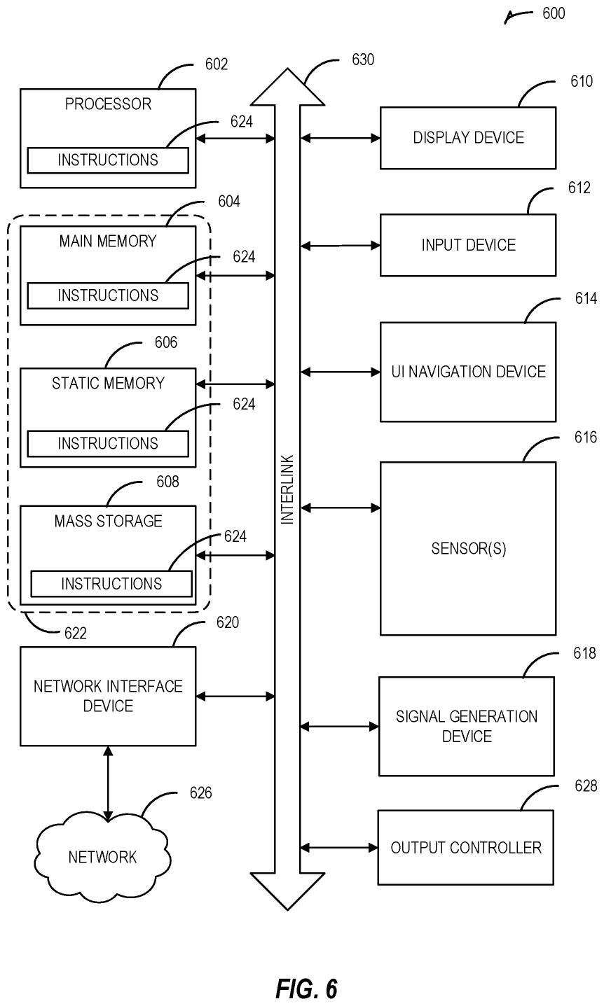

FIG. 6 illustrates a block diagram of an example machine 600 upon which any one or more of the techniques (e.g., methodologies) discussed herein may perform. For example, the machine 600 can be any one or more of the servers 102, and/or user devices 104A-104C. Examples, as described herein, may include, or may operate by, logic or a number of components, or mechanisms in the machine 600. Circuitry (e.g., processing circuitry) is a collection of circuits implemented in tangible entities of the machine 600 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 600 follow.

In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 600 may include a hardware processor 602 (e.g., a central processing unit (CPU), a graphics processing unit (GPU), a hardware processor core, or any combination thereof), a main memory 604, a static memory (e.g., memory or storage for firmware, microcode, a basic-input-output (BIOS), unified extensible firmware interface (UEFI), etc.) 606, and mass storage 608 (e.g., hard drive, tape drive, flash storage, or other block devices) some or all of which may communicate with each other via an interlink (e.g., bus) 630. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 608, a signal generation device 618 (e.g., a speaker), a network interface device 620, and one or more sensors 616, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 602, the main memory 604, the static memory 606, or the mass storage 608 may be, or include, a machine readable medium 622 on which is stored one or more sets of data structures or instructions 624 (e.g., software) embodying or utilized by any one or more of the techniques or functions described herein. The instructions 624 may also reside, completely or at least partially, within any of registers of the processor 602, the main memory 604, the static memory 606, or the mass storage 608 during execution thereof by the machine 600. In an example, one or any combination of the hardware processor 602, the main memory 604, the static memory 606, or the mass storage 608 may constitute the machine readable media 622. While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may be further transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.16.4 family of standards, peer-to-peer (P2P) networks, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software. A transmission medium is a machine readable medium.

The above description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method, performed by a data processing system, for modifying sound fields for one or more users viewing a display, the method comprising:
identifying a location of a feature in display data for output on a hardware display, the feature representing an object to be displayed on the hardware display;
determining a position where the feature will be displayed on the hardware display based upon the location of the feature in the display data and display characteristics of the hardware display;
obtaining image data from an image capture device communicatively coupled to the processor;
identifying a user in the image data from the image capture device;
calculating a location of the user in the image data relative to a position of the hardware display based upon a relative position of the image capture device to the hardware display, image capture device characteristics, and the location of the user data in the image data;
calculating a position of the user relative to the feature based upon the displayed position of the feature and the location of the user in the image data relative to the position of the hardware display;
modifying an audio stream to modify a sound field for one or more audio output devices using the location of the user in the image data relative to the position of the feature; and
causing play out of the audio stream to generate the modified sound field for the user.

2. The method of claim 1, wherein the one or more audio output devices comprise a plurality of audio output devices, and wherein the audio stream comprises a respective channel for each of the plurality of audio output devices, and wherein modifying the audio stream to modify the sound field comprises modifying, for an audio component associated with the feature, a respective magnitude of a respective signal provided for each of the respective channels such that the user experiences the audio component as coming from a direction of the feature on the hardware display.

3. The method of claim 2, wherein the plurality of audio output devices comprise headphones comprising a left ear speaker and a right ear speaker, and wherein modifying the respective magnitude comprises modifying respective magnitudes of respective signals provide for each of the left ear speaker and the right ear speaker.

4. The method of claim 1, wherein the feature is a first feature, and wherein the method further comprises:
identifying a location of a second feature in the display data;
determining a position where the second feature will be displayed on the hardware display based upon the location of the second feature in the display data and the display characteristics of the hardware display; and
identifying a position of the user relative to the second feature based upon the displayed position of the second feature and the location of the user in the image data relative to the position of the hardware display;
wherein modifying the audio stream comprises modifying the audio stream to modify the sound field for the one or more audio output devices based upon the location of the user in the image data relative to the position of the first feature and the second feature.

5. The method of claim 4, wherein the audio stream comprises a first audio component associated with the first feature and a second audio component associated with the second feature, and wherein modifying the audio stream comprises:
modifying the first audio component to modify the sound field based upon the location of the user in the image data relative to the position of the first feature;
modifying the second audio component to modify the sound field based upon the location of the user in the image data relative to the position of the second feature; and
providing the first and the second audio components to the audio stream.

6. The method of claim 1, wherein the image capture device is a camera, and wherein the image data comprises a first video frame of video data obtained by the camera.

7. The method of claim 6, further comprising:
obtaining a second video frame of the user;
identifying an updated location of the user in the second video frame relative to the position of the hardware display based upon the relative position of the camera to the hardware display, the image capture device characteristics, and the location of the user in the second video frame;
identifying an updated position of the user relative to the feature based upon the displayed position of the feature and the location of the user in the second video frame relative to the position of the hardware display;
modifying the audio stream to modify the sound field for the one or more audio output devices based upon the updated position of the user relative to the displayed position of the feature; and
causing play out of the audio stream to generate the modified sound field for the user.

8. The method of claim 1, wherein obtaining the image data comprises obtaining the image data contemporaneously with display of the display data

9. The method of claim 1, wherein the feature in the display data is a feature representing an active speaker in the display data.

10. A system for modifying sound fields for one or more users viewing a display, the system comprising:
one or more hardware processors;
a memory, storing instructions, which when executed, cause the one or more hardware processors to perform operations comprising:
identifying a location of a feature in display data for output on a hardware display, the feature representing an object to be displayed on the hardware display;
determining a position where the feature will be displayed on the hardware display based upon the location of the feature in the display data and display characteristics of the hardware display;
obtaining image data from an image capture device communicatively coupled to the processor;
identifying a user in the image data from the image capture device;
calculating a location of the user in the image data relative to a position of the hardware display based upon a relative position of the image capture device to the hardware display, image capture device characteristics, and the location of the user data in the image data;
calculating a position of the user relative to the feature based upon the displayed position of the feature and the location of the user in the image data relative to the position of the hardware display;
modifying an audio stream to modify a sound field for one or more audio output devices using the location of the user in the image data relative to the position of the feature; and
causing play out of the audio stream to generate the modified sound field for the user.

11. The system of claim 10, wherein the one or more audio output devices comprise a plurality of audio output devices, and wherein the audio stream comprises a respective channel for each of the plurality of audio output devices, and wherein the operation of modifying the audio stream to modify the sound field comprises an operation of modifying, for an audio component associated with the feature, a respective magnitude of a respective signal provided for each of the respective channels such that the user experiences the audio component as coming from a direction of the feature on the hardware display.

12. The system of claim 11, wherein the plurality of audio output devices comprise headphones comprising a left ear speaker and a right ear speaker, and wherein the operation of modifying the respective magnitude comprises an operation of modifying respective magnitudes of respective signals provide for each of the left ear speaker and the right ear speaker.

13. The system of claim 10, wherein the feature is a first feature, and wherein the operations further comprise:
identifying a location of a second feature in the display data;
determining a position where the second feature will be displayed on the hardware display based upon the location of the second feature in the display data and the display characteristics of the hardware display; and
identifying a position of the user relative to the second feature based upon the displayed position of the second feature and the location of the user in the image data relative to the position of the hardware display;
wherein modifying the audio stream comprises modifying the audio stream to modify the sound field for the one or more audio output devices based upon the location of the user in the image data relative to the position of the first feature and the second feature.

14. The system of claim 13, wherein the audio stream comprises a first audio component associated with the first feature and a second audio component associated with the second feature, and wherein the operation of modifying the audio stream comprises:
modifying the first audio component to modify the sound field based upon the location of the user in the image data relative to the position of the first feature;
modifying the second audio component to modify the sound field based upon the location of the user in the image data relative to the position of the second feature; and
providing the first and the second audio components to the audio stream.

15. The system of claim 10, wherein the image capture device is a camera, and wherein the image data comprises a first video frame of video data obtained by the camera.

16. The system of claim 15, wherein the operations further comprise:
obtaining a second video frame of the user;
identifying an updated location of the user in the second video frame relative to the position of the hardware display based upon the relative position of the camera to the hardware display, the image capture device characteristics, and the location of the user in the second video frame;
identifying an updated position of the user relative to the feature based upon the displayed position of the feature and the location of the user in the second video frame relative to the position of the hardware display;
modifying the audio stream to modify the sound field for the one or more audio output devices based upon the updated position of the user relative to the displayed position of the feature; and
causing play out of the audio stream to generate the modified sound field for the user.

17. The system of claim 10, wherein the operation of obtaining the image data comprises obtaining the image data contemporaneously with display of the display data

18. The system of claim 10, wherein the feature in the display data is a feature representing an active speaker in the display data.

19. A system for modifying sound fields for one or more users viewing a display, the system comprising:
means for identifying a location of a feature in display data for output on a hardware display, the feature representing an object to be displayed on the hardware display;
means for determining a position where the feature will be displayed on the hardware display based upon the location of the feature in the display data and display characteristics of the hardware display;
means for obtaining image data from an image capture device communicatively coupled to the processor;
means for identifying a user in the image data from the image capture device;
means for calculating a location of the user in the image data relative to a position of the hardware display based upon a relative position of the image capture device to the hardware display, image capture device characteristics, and the location of the user data in the image data;
means for calculating a position of the user relative to the feature based upon the displayed position of the feature and the location of the user in the image data relative to the position of the hardware display;
means for modifying an audio stream to modify a sound field for one or more audio output devices using the location of the user in the image data relative to the position of the feature; and
means for causing play out of the audio stream to generate the modified sound field for the user.

20. The system of claim 19, wherein the one or more audio output devices comprise a plurality of audio output devices, and wherein the audio stream comprises a respective channel for each of the plurality of audio output devices, and wherein the means for modifying the audio stream to modify the sound field comprises means for modifying, for an audio component associated with the feature, a respective magnitude of a respective signal provided for each of the respective channels such that the user experiences the audio component as coming from a direction of the feature on the hardware display.
